(19) United States
(12) Patent Application Publication
(10) Pub. No.: US 2016/0292748 A1
(43) Pub. Date: Oct. 6, 2016

(54) SYSTEMS AND METHODS FOR OPTIMIZING SUBSIDIES IN AN ONLINE AUCTION

(71) Applicant: Google Inc., Mountain View, CA (US)

(72) Inventor: Patrick Hummel, Cupertino, CA (US)

(21) Appl. No.: 14/678,029

(22) Filed: Apr. 3, 2015

(51) Int. Cl. G06Q 30/02; G06Q 30/08

(52) U.S. Cl. CPC G06Q 30/0277; G06Q 30/08

(57) ABSTRACT

A first candidate content item and a second candidate content item are identified. The first candidate content item has a first candidate bid value and the second candidate content item has a second candidate bid value. Subject matter of the first candidate content item is identified and compared with item information of an online marketplace to determine a similarity metric. Based on the similarity metric, the first candidate content item is determined to correspond to the online marketplace. Historical competing bid values from historical online auctions are retrieved. A distribution function is determined corresponding to the second candidate bid value. A subsidy value to apply to the first candidate bid value is provided. A combination of the first candidate bid value and the subsidy value is identified as greater than or equal to the second candidate bid value. The first candidate content item is selected for display.

### BACKGROUND

In a networked environment such as the Internet, entities such as people or companies provide information for display on web pages by a computing device. The web pages can include text, video, or audio information provided by the entities via a web page server for display on the Internet. Additional content such as electronic advertisements can also be provided by third parties for display on the web pages together with the information provided by the entities. Thus, a person viewing a web page can access the information that is the subject of the web page, as well as selected third party advertisements that may or may not be related to the subject matter of the web page.

### SUMMARY

At least one aspect is directed to a method of selecting content via a computer network. The method includes a data processing system identifying a first candidate content item from multiple candidate content items in an online auction. The first candidate content item has a first candidate bid value. The data processing system includes one or more processors and a data repository in memory. The method includes the data processing system identifying, from the data repository in memory, subject matter of the first candidate content item. The method includes the data processing system comparing the subject matter of the first candidate content item with item information of an online marketplace to determine a similarity metric between the subject matter and the item information. The method includes the data processing system determining, based on the similarity metric, that the subject matter of the first candidate content item corresponds to at least some of the item information of the online marketplace. The method includes the data processing system determining that a second candidate content item in the online auction lacks subject matter corresponding to the item information of the online marketplace. The second candidate content item can have a second candidate bid value. The method includes the data processing system retrieving, from the data repository, historical competing bid values from historical online auctions that included the first candidate content item. The method includes the data processing system determining a distribution function corresponding to the second candidate bid value. The data processing system uses the historical competing bid values to determine the distribution function. The second candidate bid value is greater than the first candidate bid value. The method includes the data processing system generating a subsidy value to apply to the first candidate bid value in the online auction. The data processing system generates the subsidy based on the distribution function. The method includes the data processing system identifying a combination of the first candidate bid value and the subsidy value as greater than or equal to the second candidate bid value. The method includes the data processing system selecting, via the online auction, the first candidate content item for display based on the combination of the first candidate bid value and the subsidy value.

Another aspect is directed to a system for selecting content via a computer network. The system includes a data processing system that includes one or more processors and a data repository in memory. The data processing system includes a matching engine, a subsidy generator, and a content selector. The matching engine identifies a first candidate content item and a second candidate content item from multiple candidate content items. The first candidate content item has a first candidate bid value and the second candidate content item has a second candidate bid value. The matching engine identifies, from the data repository in memory, subject matter of the first candidate content item. The matching engine compares the subject matter of the first candidate content item with item information of an online marketplace to determine a similarity metric between the subject matter and the item information. The matching engine determines, based on the similarity metric, that the subject matter of the first candidate content item corresponds to at least some of the item information of the online marketplace. The subsidy generator retrieves, from the data repository, historical competing bid values from historical online auctions comprising the first candidate content item. The subsidy generator determines, using the historical competing bid values, a distribution function corresponding to the second candidate bid value. The second candidate bid value is greater than the first candidate bid value. The subsidy generator provides, based on the distribution function, a subsidy value to apply to the first candidate bid value in the online auction. The content selector identifies a combination of the first candidate bid value and the subsidy value as greater than or equal to the second candidate bid value. The content selector selects the first candidate content item for display based on the combination of the first candidate bid value and the subsidy value.

Yet another aspect is directed to a non-transitory computer readable storage device comprising processor executable instructions that, when executed by one or more processors, cause the one or more processors to select content. The instructions include instructions to

identify a first candidate content item and a second candidate content item from a plurality of candidate content items in an online auction. The first candidate content item has a first candidate bid value and the second candidate content item has a second candidate bid value. The instructions include instructions to determine that subject matter of the first candidate content item corresponds to at least some item information of the online marketplace, and that subject matter of the second candidate content item does not correspond to item information of the online marketplace. The instructions include instructions to determine, using historical competing bid values, a distribution function corresponding to the second candidate bid value. The second candidate bid value is greater than the first candidate bid value. The instructions include instructions to generate, based on the distribution function, a subsidy value to apply to the first candidate bid value in the online auction. The instructions include instructions to identify a combination of the first candidate bid value and the subsidy value as greater than or equal to the second candidate bid value. The instructions include instructions to select, via the online auction, the first candidate content item for display based on the combination of the first candidate bid value and the subsidy value.

### BRIEF DESCRIPTION OF THE DRAWINGS

The details of one or more implementations of the subject matter described in this specification are set forth in the accompanying drawings and the description below. Other features, aspects, and advantages of the subject matter will become apparent from the description, the drawings, and the claims.

FIG. 1 is an illustration of a system for selecting content via a computer network in accordance with an implementation.

FIG. 2 is an illustration of a method for selecting content via a computer network in accordance with an implementation.

FIG. 3 is a schematic diagram of a system for selecting content via a computer network in accordance with an implementations.

FIG. 4 is a block diagram illustrating a general architecture for a computer system that may be employed to implement various elements of the system shown in FIG. 1 and the method shown in FIG. 2, among others, in accordance with an implementation.

Like reference numbers and designations in the various drawings indicate like elements.

### DETAILED DESCRIPTION

The disclosure relates to selecting content items (e.g., an online document, text, images, multimedia content, or online advertisement) for display in an online marketplace, such as an online application store. When selecting the content item for display, a data processing system (e.g., content server, contextual serving system, advertisement server) receives bids from numerous content providers (e.g., advertisers) and enters them into an online auction (e.g., an online advertisement bidding auction). The content provider that provides the highest bid may win the auction, resulting in their content item being selected for display.

When the content provider or advertiser wins the auction, the content provider compensates the administrator of the auction (e.g., pays an amount corresponding to the winning bid). However, certain content items or advertisements may provide additional benefits to an administrator of an advertisement server. For example, the advertisement server may be associated with an online marketplace. Thus, an advertisement that advertises for a product in the online marketplace may provide an additional benefit because the advertiser would pay the winning bid amount, and displaying the advertisement may result in a purchase or other transaction from the online marketplace.

Thus, system and methods of the present disclosure relate to optimizing the adjustment of an auction subsidy that increases the likelihood of certain advertisements winning the auction. In particular, the present disclosure computes the optimal subsidy by taking into account a distribution of bids of competitors in the auction. The computation can take into account one or more of the following factors: (1) whether the advertiser would win without a subsidy; (2) an advertisement for the online marketplace that would have lost, but now wins with the subsidy; or (3) an advertisement for an online marketplace is losing the auction, and still loses after providing subsidy.

The system can use one or more techniques to account for the these three factors to determine the optimal subsidy. The system can compute the cumulative distribution function corresponding to the distribution of the two highest bids that the advertiser for the item in the online marketplace is competing against by analyzing the distribution of bids that this advertiser has faced in previous auctions. The system can compute the probability density function corresponding to the cumulative distribution function. The system can compute the marginal probability density function for the highest bid that the advertiser for the item in the online marketplace is competing against using the probability density function computed. The system can compute the cumulative distribution function corresponding to the marginal probability density function.

The system may then apply one or more techniques for computing the subsidy for a content item for an item in the online marketplace. In a first technique, the system computes a fixed monetary amount that is added to this content provider's bid. The cost the content provider pays for the advertising opportunity would then be reduced by this amount if this advertiser wins the auction. The system can maximize a weighted average of economic efficiency (the total economic welfare of all the relevant participants in the market) and revenue.

In a second technique, the system can compute a fixed or predetermined number of credits to be awarded to an advertiser every time the advertiser wins the auction. An advertiser may later use the credits as consideration for goods or services, or to place future bids in the online auction. The system may determine the effect the subsidy has on the online marketplace's welfare rather than also considering the effect the subsidy has on the auction more generally through any effect this has on overall economic efficiency and overall revenue. The system can compute the optimal fixed number of credits to be awarded to maximize the online marketplace's profits.

In a third technique, the system computes a fixed or predetermined percentage to be added to the advertiser's bid. The cost the advertiser pays for the advertising opportunity may be reduced by this percentage if this advertiser wins the auction. The system can seek to maximize a weighted average of economic efficiency (the total economic welfare of all the relevant participants in the market) and revenue.

In a fourth technique, the system can compute a number of credits to be awarded to an advertiser when the advertiser wins the auction, where this number of credits is equal to a fixed or predetermined percentage of the advertiser's costs. However, if the system implements the subsidy using credits rather than by making direct changes to display advertisement auctions, the system may again wish to only focus on the effect the subsidy has on the online marketplace's welfare. The system can compute the optimal number of credits to be awarded to maximize the online marketplace's profits and this number of credits is equal to a fixed percentage of the advertiser's costs.

Thus, the system can decide both whether to offer a subsidy as well as the size of the subsidy to offer based on the distribution of bids that the advertiser is competing against. The system can preserve the incentive for advertisers to bid truthfully in the auction. The system optimally decides both whether to offer a subsidy as well as the size of the subsidy to offer based on the distribution of bids that the advertiser is competing against. The system allows this subsidy to depend on the distribution of bids the advertiser is competing against, so the owner of the advertising system may achieve greater profits that would have been achieved by not using a subsidy.

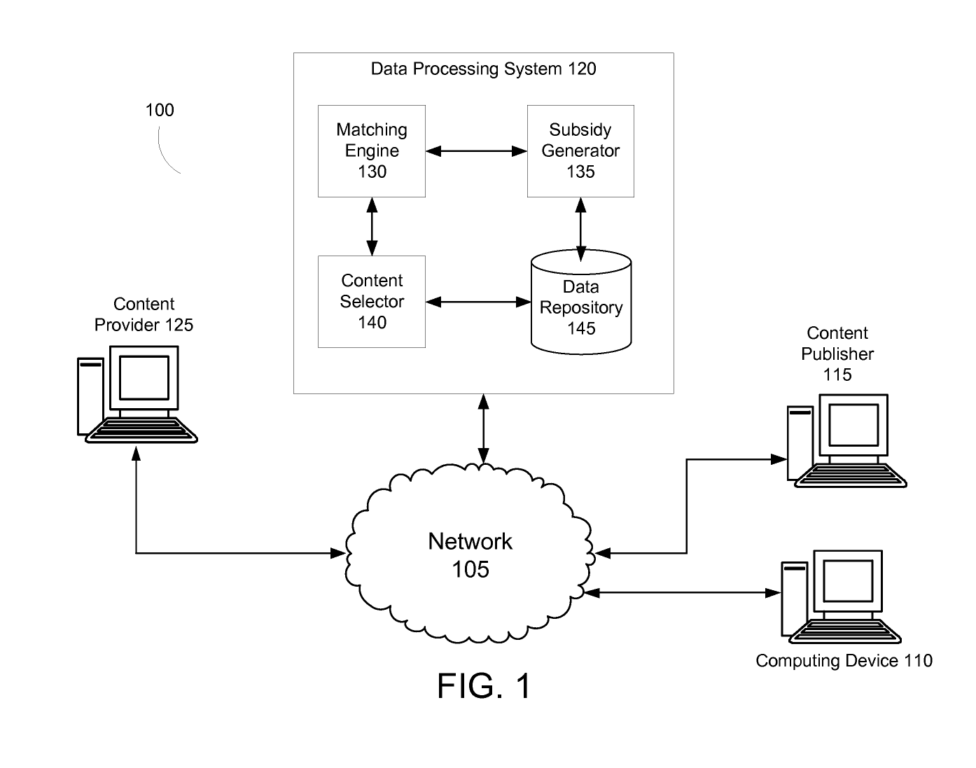

FIG. 1 illustrates an example system 100 for selecting content via a computer network. The content selection infrastructure can include a data processing system 120 communicating with one or more of a content provider 125, content publisher 115 or computing device 110 via a network 105. The network 105 can include computer networks such as the Internet, local, wide, metro, or other area networks, intranets, satellite networks, and other communication networks such as voice or data mobile telephone networks. The network 105 can be used to access information resources such as web pages, web sites, domain names, or uniform resource locators that can be displayed on at least one computing device 110, such as a laptop, desktop, tablet, personal digital assistant, smart phone, or portable computers. For example, via the network 105 a user of the computing device 110 can access web pages provided by at least one web site operator or content publisher 115. In this example, a web browser of the computing device 110 can access a web server of the web site operator or content publisher 115 to retrieve a web page for display on a monitor of the computing device 110. The web site operator or content publisher 115 generally includes an entity that operates the web page. In one implementation, the web site operator or content publisher 115 includes at least one web page server that communicates with the network 105 to make the web page available to the computing device 110.

The data processing system 120 may include or provide access to an online marketplace that facilitates the exchange of items. Items may include, e.g., electronic applications, digital media (e.g., music, television shows, movies, books, magazines, etc.), physical products (e.g., books, goods, widgets, etc.), or other goods or services. The online marketplace may be associated with the data processing system 120 in that an entity that administrates the data processing system 120 may also administrate the online marketplace (e.g., a company owns both the data processing system 120 and the online marketplace). Users via computing devices 110 may purchase items on the online marketplace by exchanging a monetary amount, token amount, points, items, etc. in consideration for an item in the online marketplace. In some cases, the online marketplace may execute on a server separate from the data processing system 120. For example, the online marketplace may execute on a third party server, and the data processing system may request information from the online repository via network (information such as item information), and may also provide content items for display via the online marketplace via the network.

The network 105 may be any type or form of network and may include any of the following: a point-to-point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network and a wireline network. The network 105 may include a wireless link, such as an infrared channel or satellite band. The topology of the network 105 may include a bus, star, or ring network topology. The network may include mobile telephone networks using any protocol or protocols used to communicate among mobile devices, including advanced mobile phone protocol (“AMPS”), time division multiple access (“TDMA”), code-division multiple access (“CDMA”), global system for mobile communication (“GSM”), general packet radio services (“GPRS”) or universal mobile telecommunications system (“UMTS”). Different types of data may be transmitted via different protocols, or the same types of data may be transmitted via different protocols.

The system 100 can include at least one data processing system 120. The data processing system 120 can include at least one logic device such as a computing device having a processor to communicate via the network 105, for example with the computing device 110, the web site operator or content publisher computing device 115, and at least one content provider computing device 125. The data processing system 120 can include at least one server. For example, the data processing system 120 can include a plurality of servers located in at least one data center. The data processing system 120 can include multiple, logically-grouped servers and facilitate distributed computing techniques. The logical group of servers may be referred to as a server farm or a machine farm. The servers can also be geographically dispersed. A machine farm may be administered as a single entity, or the machine farm can include a plurality of machine farms. The servers within each machine farm can be heterogeneous—one or more of the servers or machines can operate according to one or more type of operating system platform.

Servers in the machine farm can be stored in high-density rack systems, along with associated storage systems, and located in an enterprise data center. For example, consolidating the servers in this way may improve system manageability, data security, the physical security of the system, and system performance by locating servers and high performance storage systems on localized high performance networks. Centralizing the servers and storage systems and coupling them with advanced system management tools allows more efficient use of server resources.

The data processing system 120 can include a content placement system having at least one server. The data processing system 120 can also include at least one matching engine 130, at least one subsidy generator 135, at least one content selector 140, and at least one data repository 145. The matching engine 130, subsidy generator 135, content selector 140 and data repository 145 can each include at least one processing unit or other logic device such as programmable logic array engine, or module configured to communicate with the database 160. The matching engine 130, subsidy generator 135, content selector 140 and data repository 145 can be separate components, a single component, or part of the data processing system 120. The system 100 and its components, such as a data processing system, may include hardware elements, such as one or more processors, logic devices, or circuits.

The data processing system 120 can obtain anonymous computer network activity information associated with a plurality of computing devices 110. A user of a computing device 110 can affirmatively authorize the data processing system 120 to obtain network activity information corresponding to the user's computing device 110. For example, the data processing system 120 can prompt the user of the computing device 110 for consent to obtain one or more types of network activity information, such as geographic location information. The identity of the user of the computing device 110 can remain anonymous and the computing device 110 may be associated with a unique identifier (e.g., a unique identifier for the user or the computing device provided by the data processing system or a user of the computing device). The data processing system can associate each observation with a corresponding unique identifier.

For situations in which the systems discussed here collect personal information about users, or may make use of personal information, the users may be provided with an opportunity to control whether programs or features that may collect personal information (e.g., information about a user's social network, social actions or activities, a user's preferences, or a user's current location), or to control whether or how to receive content from the content server that may be more relevant to the user. In addition, certain data may be treated in one or more ways before it is stored or used, so that certain information about the user is removed when generating parameters (e.g., demographic parameters). For example, a user's identity may be treated so that no identifying information can be determined for the user, or a user's geographic location may be generalized where location information is obtained (such as to a city, ZIP code, or state level), so that a particular location of a user cannot be determined. Thus, the user may have control over how information is collected about the user and used by a content server.

The data processing system 120 can receive a request for content. The request may include a query such as a search query input into a search engine. The input query may include text, characters, symbols, etc. The data processing system 120 may receive the input query from a computing device 110 via network 105. The input query may include audio (e.g., words spoken by a user of the computing device 110 and input into the search engine of the data processing system via network 105 and interface 135). The request include or be associated with information that facilitates selecting content responsive to the request. The information may include, e.g., contextual information about an electronic document or web page on which the selected content is to be displayed.

Responsive to the search query or other request for content, the data processing system 120 (e.g., via content selector 140) can identify, select or otherwise obtain content to be provided or presented via the computing device 110 making the request, or some other computing device 110 associated with the request for content. In some implementations, the data processing system 120 may identify, select, or otherwise obtain content not responsive to receiving any request. The content may include, e.g., text, characters, symbols, images, video, audio, or multimedia content. The request for content can include a request for an online advertisement, article, promotion, coupon, or product description. The data processing system 120 can receive the request from a computing device such as, e.g., computing device 110. For example, the data processing system 120 can receive the request via an application executing on the computing device 110, such as a mobile application executing on a mobile device (e.g., smart phone or tablet). In some instances, a web page may request content from the data processing system 120 responsive to a user of a mobile device 110 visiting the web page (e.g., via a mobile device 110).

The request for content can include information that facilitates content selection. For example, the data processing system 120 may request information from the computing device 110 to facilitate identifying content or content selection. The data processing system 120 may request or obtain information responsive to receiving a request for content from the computing device 110. The information may include information about displaying the content on the computing device 110 (e.g., a content slot size or position) or available resources of computing device 110 to display or otherwise manipulate the content.

The data processing system 120 may identify multiple content items (e.g., a first candidate content item and a second candidate content item) that are responsive to the request for content, or are otherwise candidates for display on an online document (e.g., a web page or a page of an online marketplace). The data processing system may initiate or utilize an online auction process to select one or more of the multiple content items for display on the online document. An auction system may determine two or more bids for content items to be displayed in an online document. The auction system can run the bids through an auction process to determine one or more winning bids. Content items corresponding to the winning bids may be selected for display on or with the online document.

The data processing system 120 may include a matching engine 130. The matching engine 130 may analyze, parse, or otherwise process subject matter of candidate content items to determine whether the subject matter of the candidate content items correspond to the online marketplace. The matching engine 130 may identify, analyze, or recognize terms, characters, text, symbols, or images of the candidate content items using an image processing technique, character recognition technique, or database lookup. The candidate content items may include metadata indicative of the subject matter of the candidate content items, in which case the matching engine 130 may process the metadata to determine whether the subject matter of the candidate content item corresponds to the online marketplace.

Content providers may provide additional indicators when setting up a content campaign that includes content items. The content provider may provide information at the content campaign or content group level that the matching engine 130 may identify by performing a lookup using information about the candidate content item. For example, the candidate content item may include a unique identifier, which may map to a content group, content campaign, or content provider. The matching engine 130 may determine, based on information stored in data repository 145 about the content provider (e.g., an electronic application developer), that the candidate content item corresponds to an electronic application.

The matching engine 130 can use the identified information about the candidate content item to determine a similarity metric between the subject matter of the candidate content item and the online marketplace. The similarity metric may indicate a likelihood that subject matter of the candidate content item corresponds to an item being exchanged via the online marketplace. For example, the candidate content item may be an advertisement for a mobile phone game. The online marketplace may include the online mobile phone game. Thus, the similarity score between the candidate content item and the online marketplace would indicate a high level of similarity. The similarity metric may include a numeric score (e.g., scale of 1 to 10 with 10 being the most similar, or vice versa; a grade such as A, B, C; a binary value such as YES or NO, or 0 or 1; a color, a flag, or other indicator that indicates whether the subject matter of the candidate content item corresponds to the online marketplace.

The matching engine 130 can perform a lookup in data repository 145 using the identified subject matter from the candidate content item to determine the similarity metric. The data repository 145 may include a list or index of items provided via the online marketplace. The list may include names of items, titles, authors, producers, serial numbers, SKU numbers, UPC codes, bar codes, or other identifying information about items provided via the online marketplace. The matching engine 130 can compare the subject matter of the candidate content item with the item information stored in the data repository to determine a level of similarity. For example, the matching engine 130 may determine, based on the similarity metric, that a first candidate content item contains subject matter that corresponds to the online marketplace (e.g., an advertisement for a game that is sold via the online marketplace). However, the matching engine 130 may determine, based on a second similarity metric, that a second candidate content item contains lacks subject matter that corresponds to the online marketplace (e.g., an advertisement for tax services that are not provided via the online marketplace).

The data processing system 120 can flag the candidate content items based on the similarity metric or otherwise store or associate the similarity metric with the candidate content item in the data repository 145 for further processing.

The data processing system 120 may include a subsidy generator 135. The subsidy generator 135 can be designed and constructed to determine a subsidy value to apply to a bid in an online auction. For example, the matching engine 130 may determine that a first candidate content item includes subject matter that benefits the auctioneer and a second candidate content item lacks subject matter that benefits the auctioneer. Thus, the subsidy generator 135 may determine to apply a subsidy to the first candidate content to increase the likelihood that the first candidate content item wins the auction, resulting in the first candidate content item being selected for display on an online document.

The subsidy generator 135 may determine the subsidy based on how valuable the content item display opportunity is to the content provider, and how valuable this display opportunity is to the online marketplace (or administrator of the data processing system or auctioneer) of displaying the content item (beyond any revenue that the auctioneer obtains from the auction itself). The subsidy generator 135 may use a distribution function to determine a likelihood of the candidate content item winning the auction in various scenarios. The distribution function may represent a likelihood of a candidate content item winning the auction with and without a subsidy. For example, the distribution function may represent a first likelihood of selection of the first candidate content item absent the subsidy to the first candidate bid value. The distribution function may also represent a second likelihood of selection of the first candidate content item with the subsidy applied to the first candidate bid value. The distribution function may also represent a third likelihood of selection of a competing content item with the subsidy applied to the first candidate bid value of the first candidate content item.

For example, v_{α} denotes the value of an advertising opportunity to an advertiser for an electronic application in an online electronic application store, and v_{g} denotes the value that the online electronic application store would obtain if this advertisement is shown in the auction. Also p₁ and p₂ denote the highest and second-highest competing bids in the auction, and (p₁, p₂) may be a random draw from a cumulative distribution function F(p₁,p₂) with corresponding probability density function f(p₁, p₂). Further, g(p₁)≡∫₀^{p}^{₁} f(p₁,p₂) dp₂ denotes the marginal probability density function for p₁ and G(p₁)≡∫₀^{p}^{₁} g(x) dx denotes the corresponding cumulative distribution function. These competing bids may be from content items or advertisements that lack subject matter corresponding to the online marketplace (e.g., advertisements that are not for an electronic application in the online electronic application store) and from which the auctioneer or the administrator of the data processing system 120 would obtain no direct benefit from showing the content item (beyond the revenue the auctioneer would obtain from the auction). Finally, b denotes the bid placed by the advertiser for a content selection criteria (e.g., an electronic application in the online electronic application store, a keyword, or geographic location).

The subsidy generator 135 may determine an optimal subsidy using one or more techniques. In a first technique, the subsidy generator 135 determines a subsidy s if when the system offers a subsidy of s, then the system would effectively place a bid of b+s (e.g., combining the subsidy with the bid) in the auction for the content item corresponding to the online marketplace (e.g., an advertisement for an electronic application in an online marketplace), and reduce this content provider's payment by s if the content provider wins the auction. The content item corresponding to the online marketplace may win the auction if b+s≧p₁, and this advertiser would then pay a price of p₁−s if the advertiser wins the auction.

If the system uses a subsidy of s, then the content provider of the content item corresponding to the online marketplace will win the auction whenever p₁≦vₐ+s, and the auctioneer will obtain revenue of p₁−s conditional on this content provider winning the auction. The total value to the administrator of the data processing system (e.g., the auctioneer and administrator of the online marketplace being the same company) from this content item winning the auction is v_{g}+p₁−s. This content item would fail to win the auction whenever p₁>vₐ+s, in which case the auctioneer would obtain revenue of max {p₂, vₐ+s}. Thus the administrator of the data processing system's expected profit from using a subsidy of s is ∫₀^{v}^{ₐ}^{+s}(v_{g}+p₁−s)g(p₁)dp₁+∫ₚ_{ₐ₊ₛ}^{∞}∫₀^{p}^{₁} max{p₂, vₐ+s}f(p₁,p₂)dp₂dp₁.

If the content item corresponding to the online marketplace wins the auction, then total economic efficiency (the total economic welfare of all the relevant participants in the market) is vₐ+v_{g} and if this content item does not win the auction, then total economic efficiency is p₁. Thus expected economic efficiency from using a subsidy of s is ∫₀^{v}^{ₐ₊ₛ}(vₐ+v_{g})g(p₁)dp₁+∫ᵥ_{ₐ₊ₛ}^{∞}p₁g(p₁)dp₁.

To maximize a weighted average of economic efficiency and the administrator's revenue, where the subsidy generator 135 places a weight λ on efficiency and weight 1−λ on revenue, the optimal subsidy is determined as the subsidy s≧0 that maximizes

∫₀^{v}^{ₐ}^{+s}(λvₐ+v_{g}+(1−λ)(p₁−s))g(p₁)dp₁+λ∫ᵥ_{ₐ}₊ₛ^{∞}p₁g(p₁)dp₁+(1−λ)∫ᵥ_{ₐ}₊ₛ^{∞}∫₀^{p}^{₁} max[p₂,vₐ+s}f(p₁,p₂)dp₂dp₁ (1)

The subsidy generator 135 can differentiate this expression with respect to s, which provides:

$$( {v}_{a} + {v}_{g} ) g ( {v}_{a} + s ) - ( 1 - λ ) {\int }_{0}^{{v}_{a + s}} g ( {p}_{1} ) d {p}_{1} - λ ( {v}_{a} + s ) g ( {v}_{a} + s ) - ( 1 - λ ) {\int }_{0}^{{v}_{a + s}} ( {v}_{a} + s ) f ( {v}_{a} + s , {p}_{2} ) d {p}_{2} + ( 1 - λ ) {\int }_{{v}_{a} + s}^{∞} {\int }_{0}^{{v}_{a} + s} f ( {p}_{1} , {p}_{2} ) d {p}_{2} d {p}_{1} = ( {v}_{g} - s ) g ( {v}_{a} + s ) - ( 1 - λ ) g ( {v}_{a} + s ) + ( 1 - λ ) {\int }_{{v}_{a} + s}^{∞} {\int }_{0}^{{v}_{a} + s} f ( {p}_{1} , {p}_{2} ) d {p}_{2} d {p}_{1}$$

(2)

In this expression, the (v_{g}−s)g (vₐ+s) term represents the benefits from increasing the subsidy in the cases where increasing the subsidy changes which content item wins the auction, the (1−λ)G(vₐ+s) term represents the costs from having to pay a larger subsidy in cases where the content item corresponding to the online marketplace would have won the auction even in the absence of the subsidy, and the (1−λ)∫ᵥ_{ₐ}₊ₛ^{∞}∫₀^{v}^{ₐ}^{+s}f(p₁,p₂)dp₂dp₁ term represents the benefits of the increased revenue the administrator of the auctioneer will obtain from the auction by increasing the subsidy in cases where the content item corresponding to the online marketplace has the second-highest bid. The optimal subsidy s satisfies s=0 if v_{g}g(vₐ)−(1−λ)G(vₐ)+(1−λ)∫ᵥ_{ₐ}^{∞}∫₀^{v}^{ₐ}f(p₁,p₂)dp₂dp₁≦0 and will be a value of s>0 for which the expression in equation (2) is equal to zero otherwise.

In a second technique for determining an optimal subsidy, the subsidy generator 135 determines to provide credits to a content provider of the content item corresponding to the online marketplace. The data processing system 120 may convey a total of s credits when the content provider wins an auction (while not directly changing the cost paid by the advertiser or the bid the advertiser makes in the auction). The subsidy generator 135 may determine an optimal size of the subsidy s that maximizes the online marketplace's net profits.

Using such a subsidy, the content provider of the content item corresponding to the online marketplace has an incentive to make a bid of vₐ+s, the value of the advertising opportunity to the advertiser, because now every time the content provider wins an advertising opportunity, the content provider will benefit both from the value of having their content item shown (vₐ) and from the value of the credits that the content provider receives if the content provider wins the advertising opportunity (s). Thus, this content provider will win the auction if and only if p₁≦vₐ+s. If this content provider wins the auction, then the online marketplace or administrator thereof obtains a direct benefit of v_{g} and pays a fixed amount s in credits to the content provider, so the online marketplace makes a net profit of v_{g}−s. Otherwise the online marketplace obtains no direct benefit and also does not pay any credits to the content provider. Thus the online marketplace's expected profit from using this subsidy is

(v_{g}−s)G(vₐ+s) (3)

Differentiating this expression with respect to s then gives

v_{g}g(vₐ+s)−G(vₐ+s) (4)

Thus the optimal subsidy s will be zero if v_{g}g(vₐ)−G(vₐ)≦0 and will be the value of s>0 for which equation (4) equals zero otherwise.

In a third technique, the subsidy generator 135 determines an optimal subsidy that preserves the incentive for a content provider of a content item corresponding to the online marketplace to bid truthfully by reducing the content provider's payment in the auction by a certain percentage rather than a certain amount regardless of whether the content provider would have won the auction in the absence of the subsidy. For example, the subsidy generator 135 can offer a subsidy of a fraction s of the content provider's bid; then the subsidy generator 135 would effectively place a bid of b (1+s) in the auction for the content item corresponding to the online marketplace, and reduce this content item's payment by a fraction

$$\frac{1}{1 + s}$$

if this content provider wins the auction. Thus the content item corresponding to the online marketplace would win the auction if and only if b(1+s)≧p₁, and this content provider would then pay a price of

$$\frac{{p}_{1}}{1 + s}$$

if the advertiser wins the auction (while the online marketplace or administrator thereof would pay the remaining

$$\frac{{sp}_{1}}{1 + s} \text{)} .$$

In this case, the advertiser for the content item corresponding to the online marketplace wins the auction if and only if p₁≦vₐ(1+s), and the administrator of the online marketplace obtains revenue

$$\frac{{p}_{1}}{1 + s}$$

if this advertiser wins the auction. The total value to the administrator of the data processing system (e.g., auctioneer and online marketplace) from this content item winning the auction will then be

$${v}_{g} + \frac{{p}_{1}}{1 + s} .$$

This content item would fail to win the auction whenever p₁>vₐ(1+s), in which case the administrator would obtain revenue of max {p₂, vₐ(1+s)}. Thus the administrator's expected profit from using a subsidy of a fraction s of content provider's bid is

$${\int }_{0}^{{v}_{a} ( 1 + s )} ( {v}_{g} + \frac{{p}_{1}}{1 + s} ) g ( {p}_{1} ) d {p}_{1} + {\int }_{{v}_{a} ( 1 + s )}^{∞} {\int }_{0}^{{p}_{1}} max \{ {p}_{2} , {v}_{a} ( 1 + s ) \} f ( {p}_{1} , {p}_{2} ) d {p}_{2} d {p}_{1} .$$

If the content item corresponding to the online marketplace wins the auction, then total economic efficiency is vₐ+v_{g} and if this content item does not win the auction, then total economic efficiency is p₁. Thus expected efficiency from using a subsidy of a fraction s of the content provider's bid is

∫₀^{v}^{ₐ}^{(1+s)}(vₐ+v_{g})g(p₁)dp₁+∫ᵥ_{ₐ₍₁₊ₛ₎}^{∞}p₁g(p₁)dp₁

To maximize a weighted average of economic efficiency and the administrator's revenue using weight λ on efficiency and weight 1−λ on revenue, the subsidy generator 135 can determine the optimal subsidy as the fractional subsidy s≧0 that maximizes

$${\int }_{0}^{{v}_{a} ( 1 + s )} ( λ {v}_{a} + {v}_{g} + \frac{( 1 - λ ) {p}_{1}}{1 + s} ) g ( {p}_{1} ) d {p}_{1} + λ {\int }_{{v}_{a} ( 1 + s )}^{∞} {p}_{1} g ( {p}_{1} ) d {p}_{1} + ( 1 - λ ) {\int }_{{v}_{a} ( 1 + s )}^{∞} {\int }_{0}^{{p}_{1}} max \{ {p}_{2} , {v}_{a} ( 1 + s ) \} f ( {p}_{1} , {p}_{2} ) d {p}_{2} d p \qquad ( 5 )$$

Differentiating this expression with respect to s then gives

$${v}_{a} ( {v}_{a} + {v}_{g} ) g ( {v}_{a} ( 1 + s ) ) - ( 1 - λ ) {\int }_{0}^{{v}_{a} ( 1 + s )} \frac{{p}_{1}}{{( 1 + s )}^{2}} g ( {p}_{1} ) d {p}_{1} - λ {v}_{a} ( {v}_{a} ( 1 + s ) ) g ( {v}_{a} ( 1 + s ) ) - ( 1 - λ ) {v}_{a} {\int }_{0}^{{v}_{a} ( 1 + s )} {v}_{a} ( 1 + s ) f ( {v}_{a} ( 1 + s ) , {p}_{2} ) d {p}_{2} + ( 1 - λ ) {v}_{a} {\int }_{{v}_{a} ( 1 + s )}^{∞} {\int }_{0}^{{v}_{a} ( 1 + s )} f ( {p}_{1} , {p}_{2} ) d {p}_{2} d {p}_{1} = {v}_{a} ( {v}_{g} - {v}_{a} s ) g ( {v}_{a} ( 1 + s ) ) - ( 1 - λ ) {\int }_{0}^{{v}_{a} ( 1 + s )} \frac{{p}_{1}}{( 1 + {s}^{2} )} g ( {p}_{1} ) d {p}_{1} + ( 1 - λ ) {v}_{a} {\int }_{{v}_{a} ( 1 + s )}^{∞} {\int }_{0}^{{v}_{a} ( 1 + s )} f ( {p}_{1} , {p}_{2} ) d {p}_{2} d {p}_{1} \qquad ( 6 )$$

Thus in this setting the optimal fractional subsidy s would satisfy s=0 if vₐv_{g}g(vₐ)−(1−λ)∫₀^{v}^{ₐ}p₁g(p₁)dp₁+(1−λ)vₐ∫ᵥ_{ₐ}^{∞}∫₀^{v}^{ₐ}f(p₁,p₂)dp₂dp₁≦0 and would be a value of s>0 for which equation (6) equals zero otherwise.

In a fourth technique, the subsidy generator 135 determines a number of credits to provide to a content provider of a content item corresponding to the online marketplace that is proportional to the cost that the advertiser had to pay in the auction. If the cost the content provider pays in the auction is c, then the subsidy generator 135 provides the content provider a number of credits that is equal to

$$\frac{cs}{1 + s} .$$

That is, the subsidy generator 135 conveys to the content provider a number of credits that is a fraction

$$\frac{s}{1 + s}$$

of the cost the content provider had to pay in the auction. In this case, the content provider may want to win auctions in which the highest competing bid is no greater than (1+s) times the content provider's value for the advertising opportunity, so the optimal bidding strategy for the advertiser will be to make a bid vₐ(1+s) in the auction.

The above result indicates that the content provider in question wins the auction if and only if p₁≦vₐ(1+s). If this content provider wins the auction, then the online marketplace will obtain a direct benefit of v_{g} and have to pay an amount

$$\frac{{sp}_{1}}{1 + s}$$

in credits to the content provider, so the online marketplace makes a net profit of

$${v}_{g} - \frac{{sp}_{1}}{1 + s} .$$

Otherwise the online marketplace obtains no direct benefit and also does not pay any credits to the advertiser. Thus the online marketplace's expected profit from using this subsidy is

$${\int }_{0}^{{v}_{a} ( 1 + s )} ( {v}_{g} - \frac{{sp}_{1}}{1 + s} ) g ( {p}_{1} ) d {p}_{1} \qquad ( 7 )$$

Differentiating this expression with respect to s then gives

$${v}_{a} ( {v}_{g} - {v}_{a} s ) g ( {v}_{a} ( 1 + s ) ) - {\int }_{0}^{{v}_{a} ( 1 + s )} \frac{{p}_{1}}{{( 1 + s )}^{2}} g ( {p}_{1} ) d {p}_{1} \qquad ( 8 )$$

The subsidy generator 135 maximizes the online marketplace's profits by determining the subsidy s such that the optimal value of s is zero if vₐv_{g}g(vₐ)−E[p₁|p₁<vₐ]G(vₐ)≦0. Otherwise, the optimal value of s is based on equation (8).

The subsidy generator 135 can be preconfigured to select one of the four methods to determine an optimal subsidy or may select a method based on one or more factors. For example, a content provider may prefer to receive credits as a reward, and indicate this in a content campaign comprising the content item that is corresponds to the online marketplace. The subsidy generator 135 may then select a technique that determines an optimal number of credits to provide. In another example, the content provider may prefer a bid subsidy, in which case the subsidy generator may select a technique that subsidizes the bids in the auction.

The subsidy generator 135 can apply one or more of these technique to determine whether to apply a subsidy, the type of the subsidy (e.g., credits or amount), and the amount of the subsidy. The subsidy generator 135 can apply the technique in real-time (e.g., at content serving time where the data processing system selects a content item and provides the content item for display on a computing device 110, responsive to a request for content). In some implementations, the subsidy generator 135 can perform one or more aspect of the techniques in an offline mode (e.g., not at content serving time; prior to content serving time; prior to receiving a request for content). For example, the subsidy generator may obtain historical auction logs to determine a distribution function for competing bids. The historical logs may be for a previous time interval, such as the last 2 weeks, the last 4 weeks, the last 30 days, the last 60 days, the last 90 days, or some other time interval that facilitates determining an optimal subsidy.

Upon determining the subsidy value, the data processing system 120 can apply the subsidy to the content item comprising subject matter corresponding to the online marketplace. In the case of a bid subsidy, applying the subsidy may refer to combining the bid value of the content item with the subsidy amount. In the case of conveying credits to the content provider should the content provider win, applying the subsidy may not change the bid amount used in the auction; however, the number of credits will be conveyed to the content provider should the content provider win the auction.

The data processing system may then identify the first candidate content item as winning the auction based on the combination of the bid value and the bid subsidy being greater than or equal to the other bids in the auction. The bid subsidy may be zero if the subsidy technique is rewards based, or the subsidy value may be a positive non-zero amount if the subsidy system is bid subsidy based. The data processing system may then select the first candidate content item for display or provide the first candidate content item for display. If the subsidy is credits based, then the data processing system may allocate, responsive to selecting the first candidate content item, a number of credits to the account corresponding to the content provider of the first candidate content item.

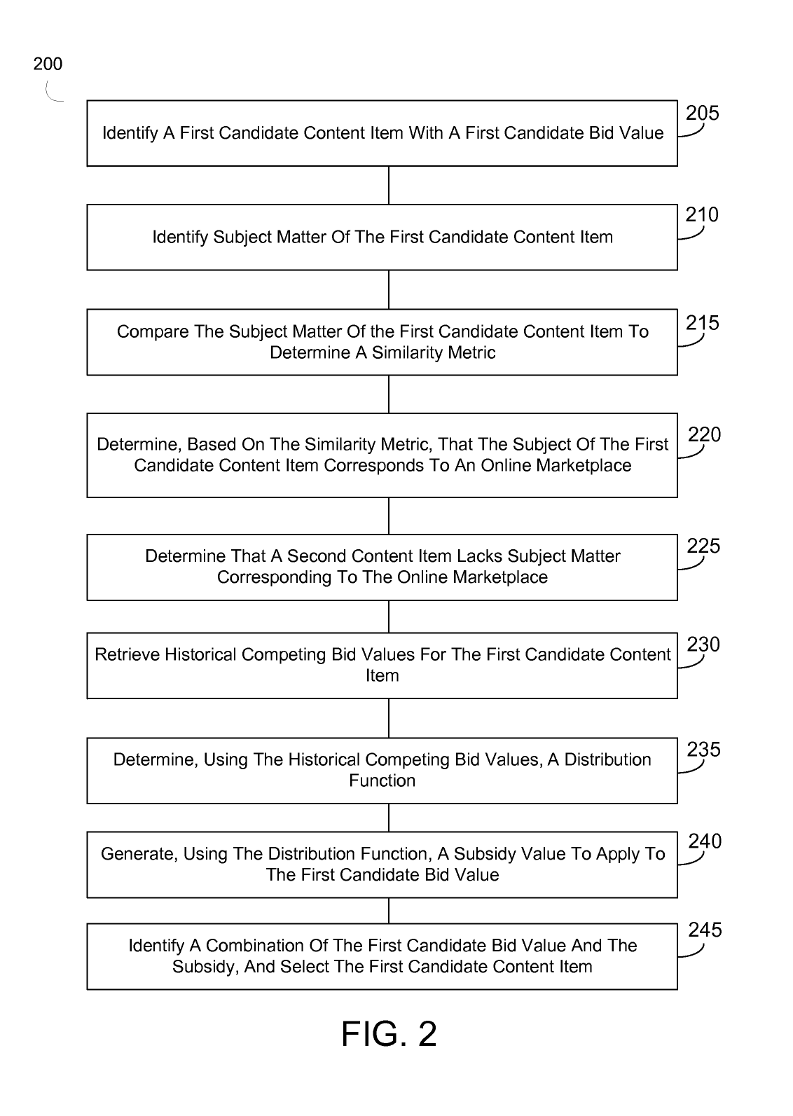

Referring now to FIG. 2, a method 200 for selecting content via a computer network in accordance with an implementation is shown. The method 200 can be performed by one or more component of system 100, data processing system 120, or computer system 400. At block 205, the data processing system identifies a first candidate content item from a pool of candidate content items in an online auction. The pool of candidate content items may have been selected by a content selector. The pool of candidate content items may be responsive to a request for a content item. The pool of candidate content items may all be suitable for display on or with an online document that is to be displayed via a end user computing device. The pool of candidate content items may be suitable for display by matching various characteristics either associated with the request for content, or the online document with which the content item is to be displayed. Each candidate content item may be associated with a respective bid value.

At block 210, the data processing system identifies, from a data repository in memory, subject matter of the first candidate content item. The data processing system may include a data repository storing information about the candidate content item or the candidate content item itself, or the data processing system may access, via a network, a second data repository that stores information about the candidate content item (e.g., a data repository associated with the content provider providing the candidate content item). The subject matter of the candidate content item may include, e.g., topical information, vertical information, genre, product type, product category, item information, title, product SKU numbers, UPC code, author, developer, etc. For example, the content item may be an advertisement for an electronic game application for a mobile telecommunications device such as a smartphone or smart watch. In some implementations, the data processing system may parse the candidate content item itself to identify the subject matter of the content item (e.g., fields of the content item, heading, description, metadata, title, lines of the content item, etc.).

At block 215, the data processing system compares the subject matter of the first candidate content item with item information of an online marketplace to determine a similarity metric between the subject matter and the item information. The data processing system 215 may perform a comparison based on matching terms, keywords or phrases of the first candidate content item (or subject matter thereof) with information about items provided via the online marketplace. The data processing system may access a data repository storing item information for items in the data repository. The item information may include the name of the item, product name, item type, item provider or manufacturer or developer, etc. For example, the name of an item in the online marketplace may be the name of an electronic application or game.

The data processing system (e.g., via a matching engine) can determine a similarity metric based on the comparison. The similarity metric may indicate a likelihood that subject matter of the candidate content item corresponds to an item being exchanged via the online marketplace. For example, the candidate content item may be an advertisement for a mobile phone game. The online marketplace may include the online mobile phone game. Thus, the similarity score between the candidate content item and the online marketplace would indicate a high level of similarity. The similarity metric may include a numeric score (e.g., scale of 1 to 10 with 10 being the most similar, or vice versa; a grade such as A, B, C; a binary value such as YES or NO, or 0 or 1; a color, a flag, or other indicator that indicates whether the subject matter of the candidate content item corresponds to the online marketplace.

At block 220, the data processing system may determine, based on the similarity metric, that a first candidate content item contains subject matter that corresponds to the online marketplace (e.g., an advertisement for a game that is sold via the online marketplace). However, at block 225, the data processing system may determine, based on a second similarity metric, that a second candidate content item lacks subject matter that corresponds to the online marketplace (e.g., an advertisement for tax services that are not provided via the online marketplace). In some implementations, there may be several candidate content items in the pool of candidate content items (e.g., a first, second, third, fourth, and fifth candidate content items). The data processing system may determine that the first candidate content item of the pool of candidate content items includes subject matter corresponding to the online marketplace, but that each of the candidate content items different from the first candidate content item are absent subject matter corresponding to item information of the online marketplace. The data processing system can determine a similarity metric for each of the remaining candidate content items and use the similarity metric to determine that the remaining candidate content items lack subject matter corresponding to the online marketplace. The data processing system may compare the similarity metric with a threshold, or the similarity metric may be a binary value that indicates the presence or absence of similarity.

At block 230, the data processing retrieves historical competing bid values from historical online auctions that includes the first candidate content item. The data repository may include auction logs for a time interval, such as the last 4 weeks, the last 2 weeks, the last 30 days, the last 60 days, or some other time interval. The auction logs may include records of bid amounts in an auction. For example, the first candidate content item may have a first bid value, and a competing content item may have a second bid value, and a second competing content item may have a third bid value. The auction record may store each of the bid values, and may further indicate the winning bid value and whether the first candidate content item won the auction or lost the auction.

An auction log may be in a table form with columns and rows, as follows:

TABLE 1
Illustrative Example of Auction Record

| Content Provider | Bid | Ad Shown? | TimeStamp |
|---|---|---|---|
| Content Provider A, | $3 | Yes | Time, [YYYY- |
| of first candidate | | | MM-DD] |
| content item | | | |
| Content Provider B, | $4 | Yes | Time, [YYYY- |
| of second candidate | | | MM-DD] |
| content item | | | |
| Content Provider C, | $2 | No | Time, [YYYY- |
| of third candidate | | | MM-DD] |
| content item | | | |

At block 235, the data processing system determines, using the historical competing bid values, a distribution function corresponding to the second candidate bid value. In some implementations, the distribution function may include a statistical distribution function. The data processing system may determine, from the historical competing values, a first cumulative distribution function for a first highest bid and a second highest bid competing against the first candidate content item based on a historic distribution of bids competing against the first candidate content item in previous online auctions. The data processing system may determine a probability density function based on the first cumulative distribution function, for example, the cumulative distribution function F(p₁) with corresponding probability density function f(p₁). If the data processing system identifies a highest and second-highest competing bids in the auction, (p₁, p₂) is a random draw from some cumulative distribution function F(p_{1, 2}) with corresponding probability density function f(p₁, p₂). The data processing system may determine, based on the probability density function, a marginal probability density function for the first highest bid competing against the first candidate content item as follows: g(p₁)≡∫₀^{p}^{₁}f(p₁, p₂)dp₂. The data processing system may determine a second cumulative distribution function corresponding to the marginal probability density function to determine the subsidy as follows: G(p₁)≡f₀^{p}^{₁}g(x)dx.

The distribution function may represent a likelihood of a candidate content item winning the auction with and without a subsidy. For example, the distribution function may represent a first likelihood of selection of the first candidate content item absent the subsidy to the first candidate bid value. The distribution function may also represent a second likelihood of selection of the first candidate content item with the subsidy applied to the first candidate bid value. The distribution function may also represent a third likelihood of selection of a competing content item with the subsidy applied to the first candidate bid value of the first candidate content item.

At block 240, the data processing system (e.g., via a subsidy generator) generates, based on the distribution function, a subsidy value to apply to the first candidate bid value in the online auction. The data processing system can determine the subsidy as a subsidy to a bid amount or as a credit to convey to the content provider upon the content provider winning the auction. The subsidy to the bid amount may be a fixed or predetermined amount (e.g., $0.1, $0.25, $1.0, or some other amount determined based on a maximization technique). The subsidy to the bid amount may be a percentage of the content provider's cost (e.g., 5%, 10%, 25%, 50%, or some other percentage determined based on a maximization technique). Similarly, the amount of credits to convey may be fixed or a percentage of the cost amount, and can be determined using a maximization technique. The content provider may use the credits as bidding credits in later auctions. For example, a credit of 5 may correspond to a $5 bid in a next auction.

The data processing system can determine the subsidy amount to maximize one or more characteristics. In a first technique, the data processing system determines a subsidy to reduce the content provider's payment should the content provider win the auction. The data processing system can then determine the subsidy to maximize a weighted average of economic efficiency and revenue for the administrator of the data processing system and online marketplace and auctioneer.

In a second technique, the data processing system provides a number of credits every time the content provider wins the auction, while not directly changing the cost paid by the content provider or the bid the content provider makes in the auction. This may incentivize the content provider to bid more in the auction as doing so may result in the content provider getting additional credits.

In a third technique, the data processing system reduces the content provider's payment in the auction by a percentage, rather than a certain amount, regardless of whether the content provider would have won the auction in the absence of the subsidy.

In a fourth technique, the data processing system provides a number of credits every time the content provider wins the auction, where the number of credits is proportional to the cost that the content provider had to pay to win the auction. This does not directly change the cost paid by the content provider or the bid the content provider makes in the auction. This may incentivize the content provider to bid more in the auction as doing so may result in the content provider getting additional credits.

In some implementations, the data processing system determines the subsidy as a predetermined number of credits to allocate to a content provider of the first candidate content item. Responsive to the content provider winning the auction, the data processing system allocates the predetermined number of credits to an account of the content provider. The data processing system may determine the account based on a unique identifier associated with the content item. The content item may include the identifier of the content provider, the account number, or a campaign identifier, which the data processing system can use to determine the content provider and account number thereof. Thus, the credits may be electronically transferred to an electronic online account of the content provider in response to the content provider winning the auction. In some cases, the data processing system can transfer or allocate credits in real-time (e.g., upon winning the auction), while in other cases the data processing system may transfer credits on a periodic basis (e.g., daily, weekly, monthly), in a batch mode, or when a certain number of credits have been accumulated (e.g., after accumulating $500 worth of credits).

If the first candidate content item wins the auction, the data processing system can provide the first candidate content item for display via an interface of the online marketplace. In some implementations, the data processing system may provide the subsidy value and not actually conduct the online auction. In some implementations, the data processing system may conduct the online auction and provide an indicator to a content serving system of the winning content item, and the content serving system may provide the content item to the computing device for display.

For example, the data processing system may identify three candidate content items. The data processing system may initiate an online auction between three candidate content items: a first candidate content item with a first candidate bid value; a second candidate content item with a second candidate bid value; and a third candidate content item with a third candidate bid value. The data processing system may determine that the first candidate content item includes subject matter corresponding to the online marketplace, but that the remaining two candidate content items lack subject matter corresponding to the online marketplace. The data processing system may determine that the first candidate bid value of the first candidate content is less than at least one of the second candidate bid value and the third candidate bid value. The data processing may determine to apply a subsidy to the first candidate bid value. The data processing system may determine the amount of subsidy. The data processing system may apply the subsidy to the first candidate bid value to generate a modified bid value. The modified bid value may be greater than the second bid value and the third value. Thus, the data processing system can apply a subsidy to the first candidate content item such that the first candidate content item wins the auction that it may have otherwise lost.

At block 240, the data processing system identifies a combination of the first candidate bid value and the subsidy value as greater than or equal to the second candidate bid value. In some implementations, the data processing system determines that the combination of the first candidate bid value and the subsidy value is great than the second candidate bid value. In some implementations, where the subsidy technique is credits based, the subsidy value may be zero.

Rather, the subsidy may be in the form of credits applied to the account associated with the content provider of the first candidate content item responsive to the first candidate content item winning the auction. In some implementations, the first candidate bid value may have been made using credits from a previous subsidy.

The data processing system selects, at block 240, via the online auction, the first candidate content item for display based on the combination of the first candidate bid value and the subsidy value. The data processing system may select the first candidate content item because it wins the auction based on the combination of the bid value and subsidy value. The combination may win the auction by being greater than the other bid values in the auction, or by being equal to or greater than the other bid values in the auction.

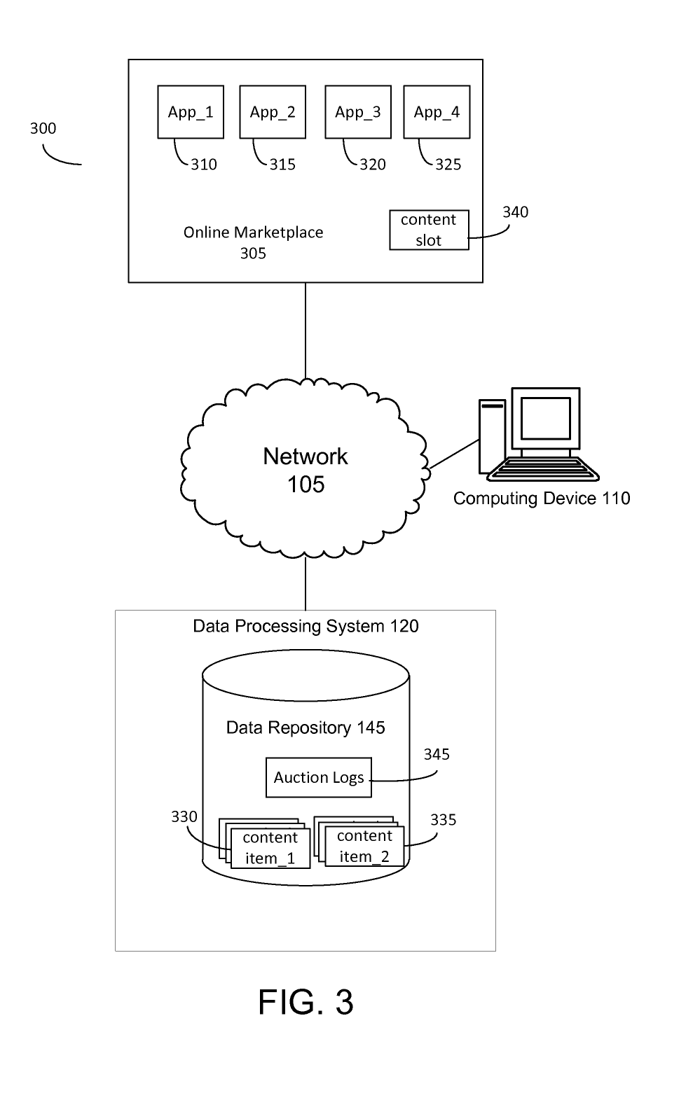

FIG. 3 is a schematic diagram of a system for selecting content via a computer network. The system 300 includes an online marketplace 305, a network 105, and a data processing system 120. The online marketplace 305 can execute or reside on its own data processing system or one or more servers thereof. The online marketplace 305 can facilitate the exchange of items. For example, the online marketplace 305 can provide, via a graphical user interface, an identification of electronic applications, such as App_1 310, App_2 315, App_3 320, and App_4 325. The online marketplace 305 may include a search or indexing feature to facilitate a user identifying items to purchase or otherwise obtain. The online marketplace 305 may include a content slot 340. The content slot 340 may refer to an advertisement slot and include a size (e.g., length and width). The content slot 340 may be a placeholder for a content item, such as an advertisement.

A computing device 110 may accesses the online marketplace 305 via network 105. The online marketplace 305 may request a content item for content slot 340. The data processing system 120 may receive, via network 105, such a request for content. The data processing system 120 may identify a first candidate content item 330 and a second candidate content item 335 from a pool of candidate content items. Each candidate content item can have a candidate bid value. For example, the first candidate content item may have been provided by a first content provider that provided a first candidate bid value, and the second candidate content item may have been provided by a second content provider that provided a second candidate bid value. The candidate content items can be stored in data repository 145 in memory.

The data processing system 120 can identify, from the data repository in memory, subject matter of the first candidate content item. The data processing system 120 can compare the subject matter of the first candidate content item 330 with item information of the online marketplace 305 to determine a similarity metric between the subject matter and the item information. The item information can include information about electronic applications 310, 315, 320, and 325. The item information may include a name, title, author, developer, genre, category, description, etc. The data processing system determines, based on the similarity metric, that the subject matter of the first candidate content item 330 corresponds to at least some of the item information of the online marketplace. For example, the first candidate content item 330 can be an advertisement for electronic application App_1 310.

The data processing system determines that a second candidate content item 335 of the plurality of candidate content items in the online auction lacks subject matter corresponding to the item information of the online marketplace 305. The second candidate content item 335 may not be an advertisement for any one of items 310, 315, 320, 325, or any other item provided for exchange via online marketplace 305.

The data processing system 120 retrieves, from auction logs 345 stored in the data repository 145, historical competing bid values from historical online auctions comprising the first candidate content item. The data processing system 120 determines, using the auction logs 345, a distribution function corresponding to the second candidate bid value, the second candidate bid value greater than the first candidate bid value. The data processing system 120 generates, based on the distribution function, a subsidy value to apply to the first candidate bid value in the online auction. The data processing system 120 identifies a combination of the first candidate bid value and the subsidy value as greater than or equal to the second candidate bid value. The data processing system 120 selects, via the online auction, the first candidate content item 330 for display based on the combination of the first candidate bid value and the subsidy value.

The data processing system 120 can provide the selected first candidate content item 330 to the online marketplace 305 for display in the content slot 340. The data processing system can provide the first candidate content item 330 via network 105. The online marketplace 305 can display the first candidate content item along with an interface, web page, or online document that displays electronic applications 310, 315, 320 and 325. This interface can be provided by the online marketplace 305 via network 105 for display on computing device 110.

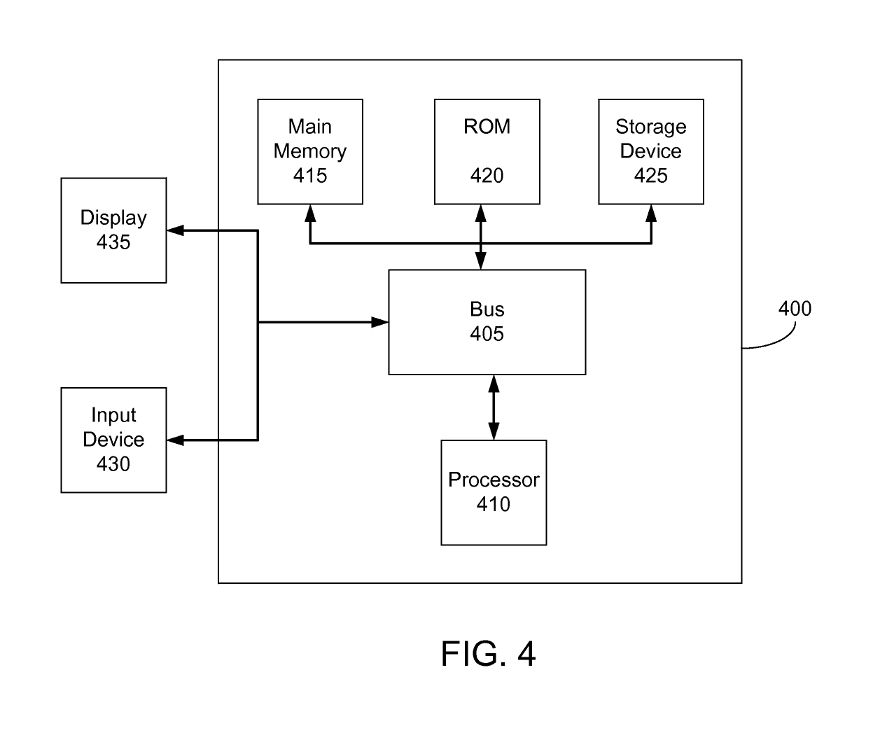

FIG. 4 is a block diagram of a computer system 400 in accordance with an illustrative implementation. The computer system or computing device 400 can be used to implement the system 100, system 300, content provider 125, computing device 110, content publisher 115, data processing system 120, matching engine 130, subsidy generator 135, content selector 140 and data repository 145. The computing system 400 includes a bus 405 or other communication component for communicating information and a processor 410 or processing circuit coupled to the bus 405 for processing information. The computing system 400 can also include one or more processors 410 or processing circuits coupled to the bus for processing information. The computing system 400 also includes main memory 415, such as a random access memory (RAM) or other dynamic storage device, coupled to the bus 405 for storing information, and instructions to be executed by the processor 410. Main memory 415 can also be used for storing position information, temporary variables, or other intermediate information during execution of instructions by the processor 410. The computing system 400 may further include a read only memory (ROM) 420 or other static storage device coupled to the bus 405 for storing static information and instructions for the processor 410. A storage device 425, such as a solid state device, magnetic disk or optical disk, is coupled to the bus 405 for persistently storing information and instructions.

The computing system 400 may be coupled via the bus 405 to a display 435, such as a liquid crystal display, or active matrix display, for displaying information to a user. An input device 430, such as a keyboard including alphanumeric and other keys, may be coupled to the bus 405 for communicating information and command selections to the processor 410. The input device 430 can include a touch screen display 435. The input device 430 can also include a cursor control, such as a mouse, a trackball, or cursor direction keys, for communicating direction information and command selections to the processor 410 and for controlling cursor movement on the display 435.

The processes, systems and methods described herein can be implemented by the computing system 400 in response to the processor 410 executing an arrangement of instructions contained in main memory 415. Such instructions can be read into main memory 415 from another computer-readable medium, such as the storage device 425. Execution of the arrangement of instructions contained in main memory 415 causes the computing system 400 to perform the illustrative processes described herein. One or more processors in a multi-processing arrangement may also be employed to execute the instructions contained in main memory 415. In alternative implementations, hard-wired circuitry may be used in place of or in combination with software instructions to effect illustrative implementations. Thus, implementations are not limited to any specific combination of hardware circuitry and software.

Although an example computing system has been described in FIG. 12, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Implementations of the subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices).

The operations described in this specification can be performed by a data processing apparatus on data stored on one or more computer-readable storage devices or received from other sources.

The term “data processing apparatus” or “computing device” encompasses various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand alone program or as a circuit, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more circuits, subprograms, or portions of code). A computer program can be deployed to be executed on one computer or on multiple computers that are located at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated in a single software product or packaged into multiple software products.

References to “or” may be construed as inclusive so that any terms described using “or” may indicate any of a single, more than one, and all of the described terms.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method, comprising:
identifying, by a data processing system comprising one or more processors and a data repository in memory, a first candidate content item from a plurality of candidate content items in an online auction, the first candidate content item having a first candidate bid value;
identifying, by the data processing system, from the data repository in memory, subject matter of the first candidate content item;
comparing, by the data processing system, the subject matter of the first candidate content item with item information of an online marketplace to determine a similarity metric between the subject matter and the item information;
determining, by the data processing system, based on the similarity metric, that the subject matter of the first candidate content item corresponds to at least some of the item information of the online marketplace;
determining, by the data processing system, that a second candidate content item of the plurality of candidate content items in the online auction lacks subject matter corresponding to the item information of the online marketplace, the second candidate content item having a second candidate bid value;
retrieving, by the data processing system from the data repository, historical competing bid values from historical online auctions comprising the first candidate content item;
determining, by the data processing system using the historical competing bid values, a distribution function corresponding to the second candidate bid value, the second candidate bid value greater than the first candidate bid value;
generating, by the data processing system based on the distribution function, a subsidy value to apply to the first candidate bid value in the online auction;
identifying, by the data processing system, a combination of the first candidate bid value and the subsidy value as greater than or equal to the second candidate bid value; and
selecting, by the data processing system via the online auction, the first candidate content item for display based on the combination of the first candidate bid value and the subsidy value.

2. The method of claim 1, further comprising:
determining, from the historical competing values, a first cumulative distribution function for a first highest bid and a second highest bid competing against the first candidate content item based on a historic distribution of bids competing against the first candidate content item in previous online auctions;
determining a probability density function based on the first cumulative distribution function;
determining, based on the probability density function, a marginal probability density function for the first highest bid competing against the first candidate content item; and
determining a second cumulative distribution function corresponding to the marginal probability density function to determine the subsidy.

3. The method of claim 1, further comprising:
initiating, by the data processing system, the online auction between the plurality of candidate content items, the plurality of content items including a third candidate content item with a third candidate bid value;
determining, by the data processing system, that the first candidate bid value of the first candidate content item is less than at least one of the second candidate bid value and the third candidate bid value; and
applying, by the data processing system, the subsidy to the first candidate bid value to generate a modified bid value, the modified bid value greater than the second bid value and the third value.

4. The method of claim 1, further comprising:
determining, by the data processing system, that each of the plurality of content items different from the first candidate content item are absent subject matter corresponding to item information of the online marketplace.

5. The method of claim 1, further comprising:
providing, by the data processing system responsive to the selecting, the first candidate content item for display via an interface of the online marketplace.

6. The method of claim 1, further comprising:
determining, by the data processing system, the subsidy as a predetermined monetary amount to add to the bid value of the first candidate content item.

7. The method of claim 1, further comprising:
determining, by the data processing system, the subsidy as a predetermined percentage to increase the first candidate bid value of the first candidate content item.

8. The method of claim 1, further comprising:
determining, by the data processing system, the subsidy as a predetermined number of credits to allocate to a content provider of the first candidate content item; and
allocating, by the data processing system responsive to selection of the first candidate content item via the online auction, the predetermined number of credits to an account of the content provider.

9. The method of claim 1, further comprising;
determining, by the data processing system, the subsidy as a number of credits corresponding to a predetermined percentage of a cost for selecting the first candidate content item via the online auction; and
allocating, by the data processing system responsive to selection of the first candidate content item via the online auction, the number of credits to an account of the content provider.

10. The method of claim 1, wherein the distribution function is indicative of:
a first likelihood of selection of the first candidate content item absent the subsidy to the first candidate bid value;
a second likelihood of selection of the first candidate content item with the subsidy applied to the first candidate bid value; and
a third likelihood of selection of one of the plurality of content items with the subsidy applied to the first candidate bid value of the first candidate content item.

11. The method of claim 1, further comprising:
receiving, by the data processing system, a request for content; and
identifying the first candidate content item response to receiving the request for content.

12. The method of claim 1, further comprising:
initiating the auction as a real-time auction performed at content serving time.

13. A system comprising:
a data processing system comprising one or more processors and a data repository in memory;
a matching engine of the data processing system that identifies a first candidate content item and a second candidate content item from a plurality of candidate content items, the first candidate content item having a first candidate bid value, the second candidate content item having a second candidate bid value;
the matching engine identifies, from the data repository in memory, subject matter of the first candidate content item;
the matching engine compares the subject matter of the first candidate content item with item information of an online marketplace to determine a similarity metric between the subject matter and the item information;
the matching engine determines, based on the similarity metric, that the subject matter of the first candidate content item corresponds to at least some of the item information of the online marketplace;
a subsidy generator of the data processing system that retrieves, from the data repository, historical competing bid values from historical online auctions comprising the first candidate content item;
the subsidy generator determines, using the historical competing bid values, a distribution function corresponding to the second candidate bid value, the second candidate bid value greater than the first candidate bid value;
the subsidy generator provides, based on the distribution function, a subsidy value to apply to the first candidate bid value;
a content selector that identifies a combination of the first candidate bid value and the subsidy value as greater than or equal to the second candidate bid value; and
the content selector selects the first candidate content item for display based on the combination of the first candidate bid value and the subsidy value.

14. The system of claim 13, wherein the data processing system is configured to:
determine that each of the plurality of content items different from the first candidate content item are absent subject matter corresponding to item information of the online marketplace.

15. The system of claim 13, wherein the online marketplace comprises an online electronic application exchange.

16. The system of claim 13, wherein the data processing system comprises the online marketplace.

17. The system of claim 13, wherein the online marketplace executes on a server separate from the data processing system.

18. The system of claim 13, wherein the data processing system:
determines, from the historical competing values, a first cumulative distribution function for a first highest bid and a second highest bid competing against the first candidate content item based on a historic distribution of bids competing against the first candidate content item in previous online auctions;
determines a probability density function based on the first cumulative distribution function;
determines, based on the probability density function, a marginal probability density function for the first highest bid competing against the first candidate content item; and
determines a second cumulative distribution function corresponding to the marginal probability density function to determine the subsidy.

19. A non-transitory computer readable storage device comprising processor executable instructions that, when executed by one or more processors, cause the one or more processors to:
identify a first candidate content item and a second candidate content item from a plurality of candidate content items in an online auction, the first candidate content item having a first candidate bid value and the second candidate content item having a second candidate bid value;
determine that subject matter of the first candidate content item corresponds to at least some item information of the online marketplace, and that subject matter of the second candidate content item does not correspond to item information of the online marketplace;
determine, using historical competing bid values, a distribution function corresponding to the second candidate bid value, the second candidate bid value greater than the first candidate bid value;
generate, based on the distribution function, a subsidy value to apply to the first candidate bid value in the online auction;
identify a combination of the first candidate bid value and the subsidy value as greater than or equal to the second candidate bid value; and
select, via the online auction, the first candidate content item for display based on the combination of the first candidate bid value and the subsidy value.

20. The non-transitory computer readable storage device of claim 19, wherein the processor executable instructions further comprise instructions to:
identify, from a data repository in memory, subject matter of the first candidate content item;
compare the subject matter of the first candidate content item with item information of an online marketplace to determine a similarity metric between the subject matter and the item information; and
determine, based on the similarity metric, that subject matter of the first candidate content item corresponds to the at least some item information of the online marketplace.
